(19) United States
(12) Patent Application Publication
(10) Pub. No.: US 2008/0057474 A1
(43) Pub. Date: Mar. 6, 2008

(54) Enlarged bottom-portion dental implant

(76) Inventors: Gangtie Zheng, Beijing (CN); Jinwen Zhu, Harbin (CN); Xin Lan, Harbin (CN)

Correspondence Address: MORRISON & FOERSTER LLP, 12531 HIGH BLUFF DRIVE, SUITE 100, SAN DIEGO, CA, 92130-2040, US

(21) Appl. No.: 11/515,147

(22) Filed: Sep. 1, 2006

(51) Int. Cl. A61C 8/00

(52) U.S. Cl. 433/173

(57) ABSTRACT

The present invention relates to dental implants. It provides an improved dental implant wherein the largest horizontal cross-section of the implanted body portion is larger than the largest horizontal cross-section of the neck portion and a method to design a dental implant using finite element analysis.

### TECHNICAL FIELD

This invention relates to dental implants. It provides an implant having improved designs over those known in the art: the improved dental implant reduces the bone resorption normally observed near the surface of the bone around a dental implant.

### BACKGROUND ART

There are several kinds of dental implants used in clinical prosthodontics, for example, screw-shaped implants, cuneiform-geometry implants, scalariform implants, cylindrical implants, and the like. In each of these designs, the cross-sectional area of the implanted bottom portion of the implant is approximately constant, or it generally narrows towards the bottom of the implanted portion. Such shapes permit the implant to be inserted with minimal removal of the bone at the surface of the jawbone that will hold the implant: the hole at the bone surface made to receive the implant must be at least as large as the largest diameter of the implanted portion. Conventional wisdom has thus held that the best designs provide a small cross-sectional area for the implanted portion, which minimizes the size of the hole in the bone surface. When implants of these shapes are used for chewing, however, there is a problem caused by stress concentration around the neck of the implant, i.e., in the marginal bone of the jawbone nearest the bone surface. This problem leads to acceleration of marginal bone resorption around implants. Furthermore, the implant can thereby become exposed and can loosen in use; as a result, often there is trouble in the appearance and most importantly in the service life of the implant.

In order to increase the useful lifetime of the implant, the stress concentration at the jawbone surrounding the neck of the dental implant should be mitigated. The present invention provides an Enlarged Bottom-Portion Dental Implant (EBDI) which mitigates the localization of stress at the surface of the jawbone around the implant, thus providing an implant that is more secure, and maintains its appearance and functionality longer because it produces less localized stress on the surrounding bone. This geometrical shape of the EBDI abandons the conventional idea that the horizontal cross-section of the implanted portion of a dental implant should diminish gradually from top to bottom.

A dental implant is described herein as having a bottom portion and a generally vertical axis that would extend from the bottom portion through the neck and through the crown. The description, for convenience only, discusses the implants as though they are oriented in the lower jaw of a user, and descriptions such as ‘down’ or ‘bottom’, ‘upward’, and ‘vertical’ refer to an implant in this position. Accordingly, the ‘bottom portion’ is the part implanted into the jawbone of the user, but a person of ordinary skill would understand that such implants can be used in the upper or lower jaw. The implants of this invention include an upper portion (crown) 1, a middle portion (neck) 2 and a bottom portion (body) 3. These portions are connected together in sequence from top to bottom as a whole structure to form the dental implants of the invention. The implants of the invention are characterized by having a neck 2 whose largest horizontal cross-sectional area is smaller than the largest horizontal cross-section area of the body 3.

Traditional implants are shaped so that the neck of the implant is at least as large in horizontal cross-sectional area as the body, or implanted part, of the implant at its largest point. This patent application provides a new concept for the design of the dental implant, in which the dental implant is divided into three parts: an upper portion 1 (can be called crown part, or “crown” for short: the portion of the implant that is at or above the gum line), a middle portion (can be called neck part, or “neck” for short: the portion of the implant above the bone and below the gum line) and a bottom portion (can be called body part, or “body” for short: the portion of the implant that is inserted into the bone). The middle portion connects the upper portion and the bottom portion.

In the implants of the invention, the largest horizontal cross-section area of the bottom portion (body) is larger than that of the middle portion (neck). Therefore, this invention is given the name of Enlarged Bottom-portion Dental Implant (EBDI). The bottom portion can choose any geometrical shape, such as irregular, spherical, cylindrical, hollow, and spiral. Some suitable shapes are referred to as round platform body, round inverse platform body, and round inverse trapezoidal body, but other shapes are also suitable for use. There is also no restriction on the shape and the size of the neck portion except that the neck is smaller in cross section than the largest portion of the body of the implant. To imitate the function of periodontal ligaments which connect the jawbone with the root of the tooth and for alleviating the impact of the implant on the jawbone, viscoelastic material can be fitted between the middle portion (neck) and/or the bottom portion (body) of the implant and its points of contact with the jawbone.

### BRIEF DESCRIPTION OF THE DRAWINGS

FIG. 1 is a diagrammatic sketch of an EBDI structure about this invention as an example.

FIG. 2 is a diagrammatic sketch of a scalariform implant.

FIG. 3 is a diagrammatic sketch of a cylindrical implant with lower part punched.

FIG. 4 is a diagrammatic sketch of a cylindrical implant with upper part punched.

FIG. 5 is a diagrammatic sketch of a cylindrical implant.

FIG. 6 is a diagrammatic sketch of a screw-shape implant.

FIG. 7 is a diagrammatic sketch of the finite element models of some dental implants and the jawbone.

FIG. 8 is a diagrammatic sketch of three dimension stress distribution at the marginal bone with some dental implants whose finite element models are shown in FIG. 7.

FIG. 9 is a maximum stress value of various models of dental implants at the marginal bone just below the crown, i.e., at the neck.

FIG. 10 is a diagrammatic sketch of path (A-B-C) at which the stress distribution along the marginal bone is picked up.

FIG. 11 is a comparison of the maximum stress values for various models at the marginal bone.

FIG. 12 is a comparison graph of shear stress values for various models at the marginal bone just below the crow part.

FIG. 13 is a diagrammatic sketch of an EBDI structure with a round platform bottom as an example.

FIG. 14 is a diagrammatic sketch of an EBDI structure with a round inverse platform bottom as an example.

FIG. 15 is the diagrammatic sketch of an EBDI structure with a round inverse trapezoidal bottom as an example.

FIG. 16 is a diagrammatic sketch of EBDI structure with spherical bottom.

FIG. 17 is a diagrammatic sketch of EBDI structure with cylindrical bottom.

FIG. 18 is a diagrammatic sketch of EBDI structure with a combination of the above-mentioned body forms.

### DISCLOSURE OF THE INVENTION

The present invention, referred to as an Enlarged Bottom-portion Dental Implant (EBDI), provides a new concept for the design of a dental implant. The EBDI abandons the conventional idea that the horizontal cross-section of an implant should diminish gradually from top to bottom. By adopting an enlarged bottom portion, the EBDI effectively alleviates the problem of stress concentration at the jawbone surface region surrounding the neck of a dental implant. Therefore, the EBDI increases the security of the implant and reduces marginal bone resorption.

To describe the invention, the dental implant is divided into three parts: upper portion 1 (the crown part, or “crown”), middle portion 2 (the neck part, or “neck”) and bottom portion 3 (the body part, or “body”). These portions are connected together in sequence from top to bottom as a whole structure to form the new dental implant, though the separate parts need not be constructed of the same material and need not have the same cross-sectional shape. The shape as described herein assumes that the implant is viewed with the crown ‘up’ and the implanted portion ‘down’.

The geometrical shape of a dental implant is extremely important in clinical prosthodontics: the shape directly influences the fastness of the implant and the stress distribution at marginal bone, and more importantly, the stress distribution at the marginal bone influences the healing between the jawbone and the dental implant; therefore, a proper geometrical shape of the implant increases the support capability and reduces marginal bone resorption around the implant. The design and shape thus significantly influence the functional lifetime of the implant.

The body of the implant can assume any geometrical shape: it can be irregular, or it can be generally spherical, cylindrical, hollow, conical, bell-shaped, diamond shaped, elliptical, oval, oblate, cruciate, or spiral. To illustrate these shapes only, and without limiting the scope of the invention, some examples are provided herein and are referred to as round platform body, round inverse platform body, and round inverse trapezoidal body, each of which is depicted in the accompanying Figures. The horizontal cross-section shape can be irregular, but is often generally round, oval, elliptical, rectangular, triangular, or of another approximately symmetric regular geometric shape such as a pentagon, hexagon, or octagon, or a symmetrically elongated or distorted form of any of these, or of a symmetric or an unsymmetric variation of one of these, or of a combination of such shapes such as an oval or circle having one or more flattened or partially flattened faces.

The vertical cross-section of the body will generally be shaped at its upper part to flow into the neck of the implant, and can also be irregular in shape. Often, aside from the portion that connects to the neck, the vertical cross-section of the body is generally circular or oval or elliptical or cruciate or trapezoidal or triangular or rectangular or diamond-shaped or some combination of these. Where the bottom of the body forms a generally horizontal surface, that surface may be substantially flat; or it may be concave or convex; or the surface may be irregular.

The body may also include additional protrusions or indentations such as pins or threaded screws or a spiral or threaded outer surface that may be used to maintain the implant in a specific orientation relative to the bone, such as during installation. Some of the Figures herein depict implants having punched impressions or indentations, or having a screw-thread shape formed around at least part of the perimeter of the body, for example. It may also comprise grooves or holes or other recesses cut into the body, such as grooves in generally vertical direction to resist rotation of the implant, or grooves cut into the body in generally horizontal direction to resist vertical movement of the implant, or combinations of these. It may also comprise irregular surface features that assist in the integration and adhesion of new tissue growth or of adhesives and/or fillers that hold the implant in place and help the implant resist vertical, rotational, or horizontal movement. There is also no restriction on the shape and the size of the neck portion: it does not necessarily have the same horizontal or vertical cross-sectional shape as the body, though it often will either match the general shape of the body or alternatively be generally cylindrical. It can be of any suitable shape and size, as long as the largest horizontal cross-section area of the neck 2 is smaller than the largest horizontal cross-section area of the body 3. Combinations of these shapes and features are also contemplated.

### Modes of Carrying Out the Invention

The dental implants of the invention can be made of any materials suitable for use in such applications; suitable materials for the implants and methods for making them are well known to those of ordinary skill in the art. Some embodiments are made of materials known to be suitable for use in implanted medical devices, including, for example, alloys of cobalt and chromium; macromolecular compounds such as high molecular weight polymers, highly cross-linked polymers, light-sensitive compounds, and photo-cured polymers as well as composites containing such non-metal materials; stainless steel, preferably nickel-free; titanium and titanium alloys; and combinations of these. The implant may be held in place by new bone growth or by the use of suitable filling and adhesive materials that are known in the art for such applications, or by combinations of these.

In some embodiments, the body of the implant is substantially spherical. In some embodiments it may be flattened in the vertical dimension so that its vertical cross-sections become generally oval while its horizontal cross sections remain generally circular.

In some embodiments, the neck of the implant is substantially cylindrical. Its diameter may vary along its length, and in some embodiments the diameter of the neck increases gradually as it merges into the body of the implant. Thus it may merge into the body along a smoothly curved contour with no discontinuity where the neck and body join.

Where a shape of a part of the dental implant is described as generally of a particular shape, it is understood that it can be somewhat irregular or distorted from that shape, and that curved surfaces may be faceted rather than perfectly smooth. In some embodiments, depending on the material used, it may be preferable to leave a somewhat roughened or irregular surface on at least some parts of the body of the implant.

“Concave or convex” as used herein means that a generally horizontal surface on the bottom of the body of an implant (for example) may depart over some portion of its generally horizontal area by either extending downward (to become convex) or upward (to become concave). Typically the departure from a generally horizontal surface adopts a smoothly curving surface in a shape such as a hemisphere or typically a portion of a hemisphere, or a flattened or elongated (oval horizontal cross-section) form thereof. The approximate radius of curvature of such concave or convex portion of a surface is typically at least equal to the radius of the horizontal cross-section of the generally horizontal surface, or of a circle that circumscribes that horizontal cross-section. In some embodiments the radius of curvature of such concave or convex portion of a surface is at least 50% larger than the radius of the horizontal cross-section of the surface itself, and in some embodiments it is at least 100% larger or at least 200% larger.

While in many embodiments the overall implant has a generally cylindrical shape and varies in its horizontal cross-sections, it need not be this way. The horizontal cross-section can vary within the body or the neck or the crown, and the horizontal cross-section of the body need not match that of the neck or of the crown. Thus each part of the implant can be shaped independently as needed. Furthermore, the crown can assume any shape or configuration that is generally suitable for a dental implant, and its shape does not limit the inventive concept described herein.

FIGS. 1 and 13-18 illustrate the general shape of some embodiments of the implants of the invention; the actual relative size of the body compared to the neck and crown may be varied without departing from the invention. Typically, the neck is smaller in horizontal cross-section than the body by at least 10%, and in many embodiments the horizontal cross-sectional area of the neck is smaller than the largest cross-sectional area of the body by at least 10% or by at least 20%. In preferred embodiments, the horizontal cross-sectional area of the neck is smaller than the largest cross-sectional area of the body by at least 30% or by at least 50%.

The Figures depict the vertical cross-section of the body of the implant as generally having the shape of a sphere or a vertically or horizontally flattened sphere; or a trapezoid or inverted trapezoid, or a rectangle or series of stacked rectangles of varying sizes; or an oval or vertically or horizontally flattened oval (FIG. 16). Various combinations and distortions of the shapes shown can also be employed, as can irregular shapes. The bottom-most surfaces of some of these embodiments appear generally flat in the particular embodiments illustrated, and a typical embodiment of these shapes may appear flat in a side view; however, the bottom surface itself may still be concave or convex in order to better distribute forces within the bone or stabilize the implant, or conform to a convenient shape for the recess into which the implant will be seated.

The precise design of an implant of the invention can be evaluated and compared to other designs using a finite element analysis to determine what stress loads and distributions it provides as described in detail herein. Thus in another aspect the invention provides a method to evaluate dental implant designs by optimizing the distribution of forces created by the dental implant in the jawbone using a finite element analysis.

While some of the illustrative shapes in the Figures show square corners or sharp angles, as one of skill in the art will recognize, it is often advantageous to round such corners and angles in order to avoid sharp edges that may damage surrounding tissue or create discontinuities in the tissue-integrated implant. Thus while shapes of the features and/or cross sections of the dental implants of the invention are described with reference to familiar geometric forms having angular intersections between adjoining faces or surfaces, variants of these shapes having rounded corners, edges and angles are included in the scope of the invention, and may in some cases be preferred.

The following examples are provided to illustrate but not to limit the invention.

### EXAMPLE 1

Example 1: One embodiment of the invention includes a crown-like upper portion (crown) 1, middle portion (neck) 2 and bottom portion (body) 3, which is an organic whole being connected according to the order from top to bottom, wherein the horizontal cross-sectional area of the neck 2 is smaller than that of the body 3. In this embodiment, the neck is generally cylindrical in shape, and the body is generally spherical in shape. An embodiment of this design is depicted in vertical cross-section in FIG. 1. The neck can optionally be structured with a gradually increasing diameter as it merges into the body, which provides a smoothly curved contour.

### EXAMPLE 2

A specific embodiment of the invention includes a crown-like upper portion (crown) 1, middle portion (neck) 2 and bottom portion (body) 3. In this embodiment, a choice of dimensions is as follows: neck 2 having a generally circular horizontal cross-section of diameter d=4 mm; overall length of the implant L=18.5 mm, and embedded length L1=11 mm; generally spherical body 3 with radius r=4 mm, which is integrally connected to neck 2; neck 2 is in turn integrally connected to crown 1. The diameter of the body of the implant is approximately half as much as the thickness of the jawbone into which it will be implanted.

### EXAMPLE 3

Certain advantages of the new dental implant are illustrated by utilizing the technique of finite element analysis to compare the maximum stress values at the marginal bone generated by five other types of dental implants with an implant of the invention under the same load conditions.

1. Material properties are listed in Table 1.

TABLE 1
data on representative material properties

| Material | Elastic Modulus (Mpa) | Poisson's ratio (v) |
|---|---|---|
| Cobalt-chromium alloy | 217000 | 0.3 |
| Alveolar bone | 18620 | 0.3 |

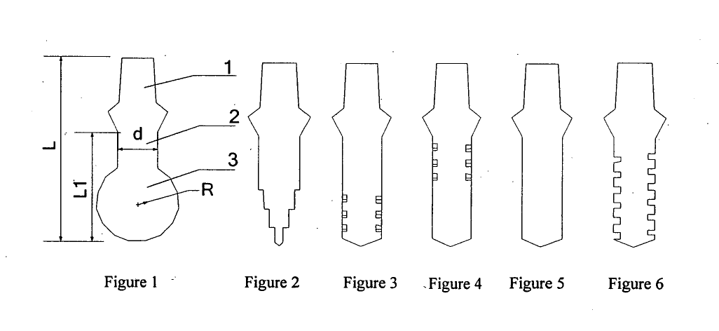

2. Models used in this analysis are defined by FIGS. 1-6.

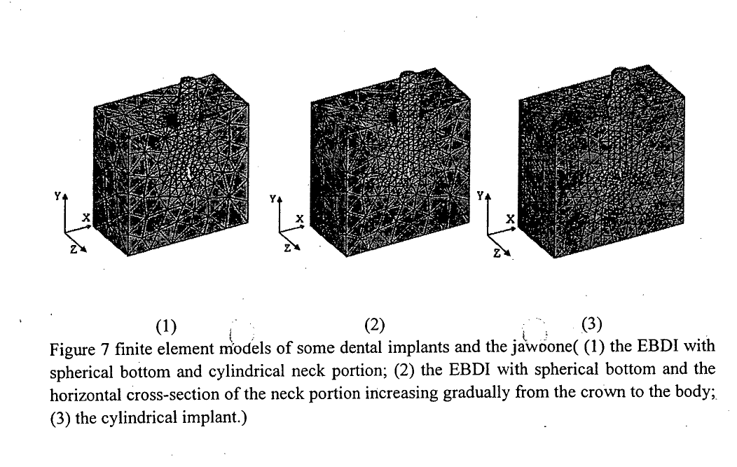

3. The finite element model of the implant is given by FIG. 7:
FIG. 7 (1) is the finite element model of an EBDI implant having a spherical bottom and a cylindrical neck portion;
FIG. 7 (2) is the finite element model of an EBDI implant having a spherical bottom and a horizontal cross-section of the neck portion that increases gradually from the crown to the body;
FIG. 7 (3) is the finite element model of a cylindrical implant.

(1) Node information is given in Table 2.

(2) Loading condition: applying vertical downward planar pressure force (P1=4000 MPa) and lateral right direction concentrated force (P2=1000N) on the implant top at the same time.

(3) Assumptions in the finite element analysis:
a. There is synosteosis between the implant and the osseous tissue, i.e., there is no relative slip between the marginal bone and the implant.
b. The implant material and osseous tissue are all continuous, isotropic and linearly elastic.
c. The displacement on the left and right sides of the jawbone model in x-direction are set to be zero, and also the displacement in z-direction on the symmetrical plane is set to be zero, in addition the bottom is fully constrained.

4. Finite element analysis results:

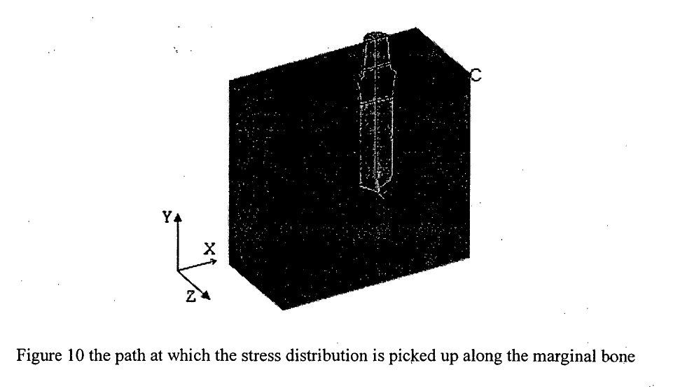

(1) Calculated stress values at the right-hand point of the marginal bone just below the crown portion (point B in FIG. 10) are listed in Table 3.

TABLE 2
Node information

| | Node | Cell |
|---|---|---|
| Form of dental implant | number | number |
| EBDI with Spherical bottom and cylindrical neck | 25436 | 23505 |
| EBDI with Spherical bottom and gradually | 26078 | 23914 |
| increased horizontal cross-section neck portion | | |
| given by FIG. 7(2) | | |
| Cylindrical implant | 28719 | 27997 |
| Cylindrical implant with lower part punched. | 39488 | 37816 |
| Cylindrical implant with upper part punched | 43988 | 44723 |
| Scalariform implant | 29087 | 28216 |
| Screw-shape implant | 28955 | 27839 |

TABLE 3
Stress values at observing points (unit: MPa)

| Form of | | | | | | | | | |
|---|---|---|---|---|---|---|---|---|---|
| implant | f₁ | f₂ | f₃ | SINT | SEQV | fₓ | f_{y} | f_{z} | τ_{xy} |
| Spherical | −761.03 | −1203.8 | −3574.5 | 2813.4 | 3014.2 | −3168.6 | −1166.8 | −1203.8 | 988.23 |
| bottom (2) | | | | | | | | | |
| Spherical | −807.49 | −1298.3 | −3879.6 | 3072.1 | 2858.5 | −3435.1 | −1253.5 | −1296.8 | 1079.9 |
| bottom (1) | | | | | | | | | |
| cylindrical | −896.03 | −1481.7 | −4288.4 | 3392.4 | 3140.8 | −3810.5 | −1375.6 | −1480 | 1179.3 |
| implant | | | | | | | | | |
| Lower part | −941.57 | −1549.2 | −4362.9 | 3421.4 | 3161.7 | −3885 | −1419.6 | −1549.1 | 1184.9 |
| punched | | | | | | | | | |
| Upper part | −914.43 | −1529.3 | −4425.7 | 3511.3 | 3247.8 | −3947.9 | −1393.4 | −1528.1 | 1202.5 |
| punched | | | | | | | | | |
| Scalariform | −948.89 | −1578 | −4556.9 | 3608 | 3338.3 | −4059.6 | −1447.9 | −1576.3 | 1242.8 |
| implant | | | | | | | | | |
| Screw-shape | −1042.5 | −1743.9 | −5090.2 | 4047.7 | 3746.6 | −4563.9 | −1570.1 | −1742.7 | 1359.8 |
| implant | | | | | | | | | |

(SINT: stress intensity, SEQV: equivalent stress intensity)

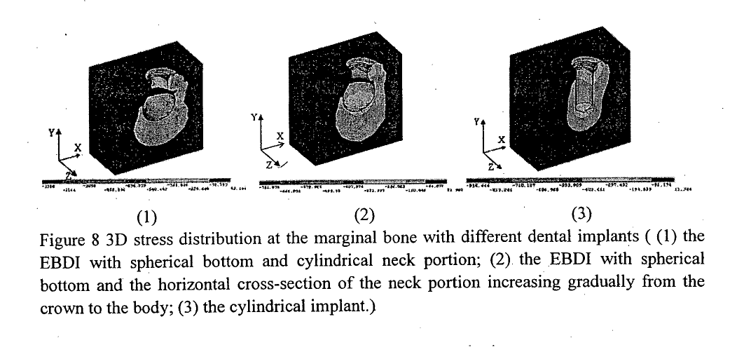

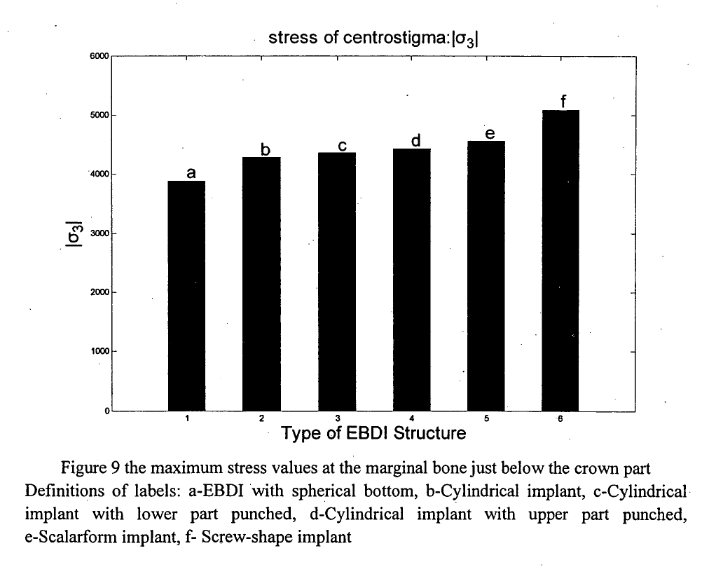

(2) Result analysis (FIGS. 8-9, 11-12 and Table 3)
a. Use the maximum stress value at point B defined in FIG. 10, i.e., the absolute value of σ₃, as criterion for evaluating the quality of an implant. (This stress is compression stress, and its value is negative; unit: Mpa):

The dental implant that has the minimal maximum stress value is the best in reducing the stress concentration at the marginal bone. The order of quality using this analysis is: Best: EBDI with Spherical bottom and gradually increased horizontal cross-section neck portion given by FIG. 7 (2); Second best: EBDI with spherical bottom; third: cylindrical implant; fourth: cylindrical implant with lower part punched; fifth: cylindrical implant with upper part punched; sixth: scalariform implant; last: screw-shaped implant. If the implant employs a neck portion whose horizontal cross-section increases gradually as it approaches the body, it increases the quality by reducing the stress on marginal bone.
b. Use the evenness index of stress distribution (i.e., the degree of stress concentration) at marginal bone as criterion for evaluating the quality of an implant.

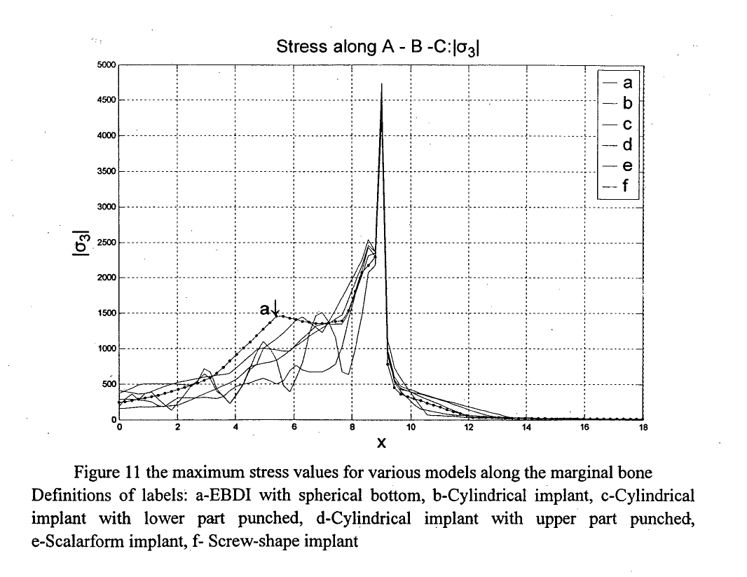

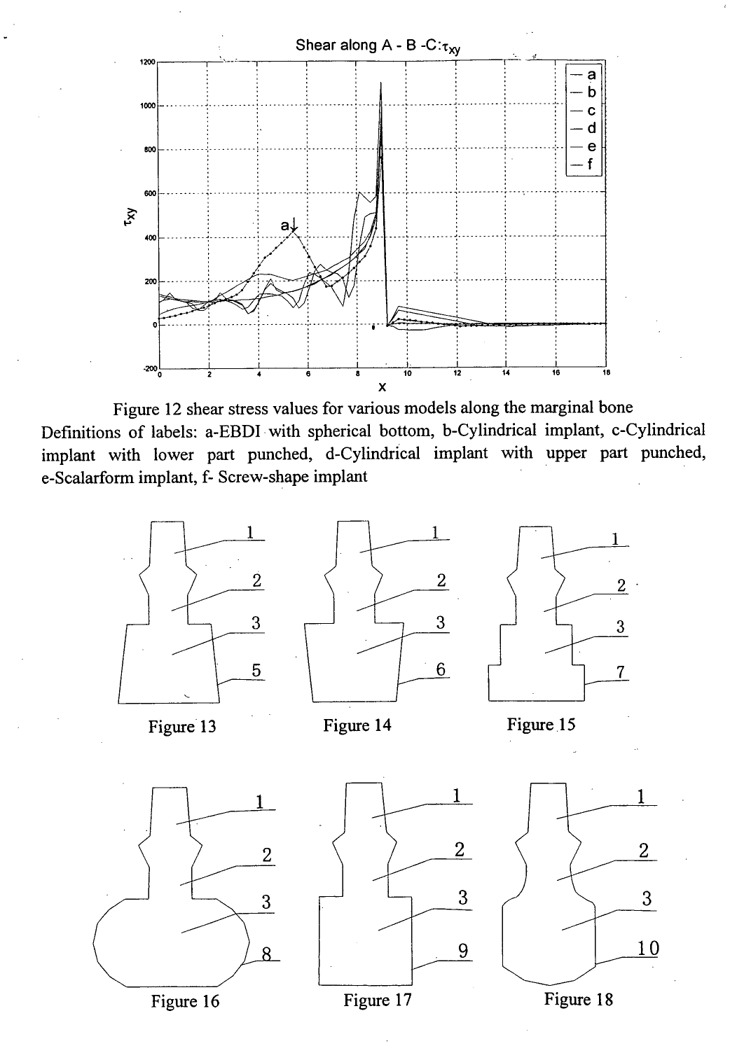

By analyzing the stress at points A, B and C (defined in FIG. 10), comparison graphs of maximum stress distributions (FIG. 11) and shear stress distributions (FIG. 12) are obtained. From FIG. 11, the following are conclusions obtained: the most even distribution of maximum stress belongs to the EBDI with a spherical bottom, the screw-shaped implant is the least even. The cylindrical implant and the cylindrical implant with lower part punched have a rather large mean stress, stress of the cylindrical implant with upper part punched has a wider fluctuation, and the scalariform implant has lower mean stress at the end-edge of the implant, whose maximum stress is equal to that of the cylindrical implant with lower part punched in the part of the neck area close to the crown part on the whole.

The conclusions drawn from FIG. 12 are the following. The most even distribution of shear stress belongs to EBDI with a spherical bottom. Shear stress of the screw-shaped implant has a wider fluctuation, and shear stress of the cylindrical implant with upper part punched is generally at the same level, but around the joint at the neck part, the former is greater than the latter. Shear stress value of the cylindrical implant varies steadily at the same level as the cylindrical implant with lower part punched. The scalariform implant has a higher level of shear stress at the end-edge of the implant, whose shear stress is equal to that of the cylindrical implant with lower part punched in the part of the neck area close to the crown part.

The overall quality of the EBDI with a generally spherical bottom is the best among those in this comparison of dental implants with respect to the maximum stress values and the distribution of stress within the adjacent bone.

More Examples of the Invented Dental Implant:

Example 4: This Example is similar to Example 1 except that the bottom portion 3 is replaced by the round platform body 5.

Example 5: This Example is similar to Example 1 except that the bottom portion 3 is replaced by the round inverse platform body 6.

Example 6: This Example is similar to Example 1 except that the bottom portion 3 is replaced by the round inverse trapezoidal body 7.

Example 7: This Example is similar to Example 1 except that the bottom portion 3 is replaced by the spheroidal body 8.

Example 8: This Example is similar to Example 1 except that the bottom portion 3 is replaced by the cylindrical body, 9.

Example 9: This Example is similar to Example 1 except that the bottom portion 3 is replaced by a combination of the above-mentioned geometrical bodies.

The examples above are offered to illustrate but not to limit the invention. Those of skill in the art will appreciate that certain aspects and embodiments of the disclosed invention can be combined or modified, and such modifications and combinations are also within the scope of the invention. The specific body shapes described herein in particular can be modified or combined, and any suitable body shape can be combined with at least one pin, groove, hole, or surface irregularity to assist in secure installation of the implant or to assist in retention of the implant, whether by a filler or adhesive or by the growth of surrounding bone tissue.

1. A dental implant comprising a crown, a neck, and a body, wherein the largest horizontal cross-sectional area of the body is larger than the largest horizontal cross-sectional area of the neck.

2. The dental implant of claim 1, wherein the horizontal cross-sectional area of the body is larger than the largest horizontal cross-sectional area of the neck by at least 10%.

3. The dental implant of claim 1, wherein the horizontal cross-section of the neck is generally circular.

4. The dental implant of claim 1, wherein the horizontal cross-section of the body is generally circular.

5. The dental implant of claim 4, wherein the neck is generally shaped as a cylinder whose circular dimension is its horizontal cross-section and whose linear axis is generally vertical.

6. The dental implant of claim 1, wherein the horizontal cross-section of the neck increases gradually as it merges into the body.

7. The dental implant of claim 1, wherein the vertical cross-section of the body is generally circular.

8. The dental implant of claim 1, wherein the vertical cross-section of the body is generally rectangular.

9. The dental implant of claim 1, wherein the vertical cross-section of the body is generally cruciate.

10. The dental implant of claim 1, wherein the vertical cross-section of the body is generally oval, wherein the major axis of the oval is generally horizontal or generally vertical.

11. The dental implant of claim 1, wherein the vertical cross-section of the body is generally trapezoidal and wherein one face of the trapezoid is generally horizontal and provides the bottom of the body.

12. The dental implant of claim 1, wherein the vertical cross-section of the body comprises a rectangle or square.

13. The dental implant of claim 1, wherein a generally horizontal bottom surface of the body is flattened.

14. The dental implant of claim 6, wherein a generally horizontal bottom surface of the body is flattened.

15. The dental implant of claim 7, wherein a generally horizontal bottom surface of the body is flattened.

16. The dental implant of claim 1, wherein a generally horizontal bottom surface of the body is substantially flat.

17. The dental implant of claim 1, wherein a generally horizontal bottom surface of the body is concave.

18. The dental implant of claim 1, wherein a generally horizontal bottom surface of the body is convex.

19. The dental implant of claim 1, further comprising at least one pin, groove, hole, or surface irregularity to assist in secure installation of the implant, or to assist retention of the implant, or to assist integration of the implant with surrounding tissues.

20. The dental implant of claim 1, further comprising viscoelastic material fitted between the middle portion (neck) and/or the bottom portion (body) of the implant and its points of contact with the jawbone.

21. A method to design or select a shape for a dental implant, comprising using a finite element analysis to optimize the distribution of forces created by the dental implant in the jawbone.
